(19) United States
(12) Patent Application Publication
(10) Pub. No.: US 2018/0160001 A1
(43) Pub. Date: Jun. 7, 2018

(54) IMAGE FORMING APPARATUS

(71) Applicant: KYOCERA Document Solutions Inc., Osaka (JP)

(72) Inventor: Kazuto Misu, Osaka (JP)

(21) Appl. No.: 15/798,098

(22) Filed: Oct. 30, 2017

(30) Foreign Application Priority Data
Dec. 1, 2016 (JP) 2016-234023

(51) Int. Cl. G03G 15/00; H04N 1/00; H04N 1/48; H04N 1/21

(52) U.S. Cl. CPC H04N 1/00925; H04N 1/48; H04N 2201/0094; G03G 15/50; G03G 15/01; H04N 1/2104

(57) ABSTRACT

An image forming apparatus includes a sheet conveying portion, an image data outputting portion, a plurality of buffer memories, an image forming portion, and a timing control portion. At least one of the plurality of buffer memories corresponding to at least one predetermined channel among the plurality of color channels other than a head color channel is configured to store image data of two different pages individually. After the image data outputting portion starts outputting image data of the first page to the buffer memory corresponding to the predetermined channel, the image data outputting portion starts outputting image data of the second page to the buffer memory regardless of whether or not the image data of the first page has been read from the buffer memory.

### INCORPORATION BY REFERENCE

This application is based upon and claims the benefit of priority from the corresponding Japanese Patent Application No. 2016-234023 filed on Dec. 1, 2016, the entire contents of which are incorporated herein by reference.

### BACKGROUND

The present disclosure relates to an image forming apparatus.

Among color printers that can switch between a monochrome print mode and a color print mode depending on an image to be printed, there is known a color printer configured to prohibit switching from the color print mode to the monochrome print mode during execution of a print job.

### SUMMARY

An image forming apparatus according to an aspect of the present disclosure includes a sheet conveying portion, an image data outputting portion, a plurality of buffer memories, an image forming portion, and a timing control portion. The sheet conveying portion conveys a sheet. The image data outputting portion outputs image data of a plurality of color channels individually. The plurality of buffer memories are provided respectively in correspondence with the plurality of color channels, and configured to temporarily store the image data of the plurality of color channels output from the image data outputting portion. The image forming portion reads the image data of the plurality of color channels in sequence in an order from a head color channel from the plurality of buffer memories at timings different for each of the plurality of color channels in synchronization with a sheet conveyance timing at which the sheet conveying portion conveys the sheet. The timing control portion requests the sheet conveying portion to convey a sheet for a second page that is next to a first page, which is an arbitrary page, in a case where: a reading completion timing at which reading image data of the head color channel of the first page from a corresponding buffer memory is to be completed, has passed; and a part of image data of the second page is stored in the corresponding buffer memory. At least one of the plurality of buffer memories corresponding to at least one predetermined channel among the plurality of color channels other than the head color channel is configured to store image data of two different pages individually. After the image data outputting portion starts outputting image data of the first page to the buffer memory corresponding to the predetermined channel, the image data outputting portion starts outputting image data of the second page to the buffer memory regardless of whether or not the image data of the first page has been read from the buffer memory.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing an outline configuration of an image forming apparatus according to an embodiment of the present disclosure.

FIG. 2 is a main-part block diagram showing a system configuration of the image forming apparatus according to the embodiment of the present disclosure.

FIG. 3 is a main-part block diagram showing a system configuration of the image forming apparatus according to the embodiment of the present disclosure.

FIG. 4 is a diagram for explaining an example of printing operation in continuous printing of color image data in a color print mode in the image forming apparatus according to the embodiment of the present disclosure.

FIG. 5 is a diagram for explaining an example of printing operation in continuous printing of monochrome image data in a monochrome print mode in the image forming apparatus according to the embodiment of the present disclosure.

FIG. 6 is a diagram for explaining an example of printing operation in continuous printing of monochrome image data in the color print mode in an image forming apparatus according to a comparative example.

FIG. 7 is a diagram for explaining an example of printing operation in continuous printing of monochrome image data in the color print mode in the image forming apparatus according to the embodiment of the present disclosure.

FIG. 8 is a flowchart showing an example of procedure of a timing control process executed in the image forming apparatus according to the embodiment of the present disclosure.

### DETAILED DESCRIPTION

The following describes an embodiment of the present disclosure with reference to the accompanying drawings for the understanding of the present disclosure. It should be noted that the following embodiment is an example of a specific embodiment of the present disclosure and should not limit the technical scope of the present disclosure.

[Configuration of Image Forming Apparatus]

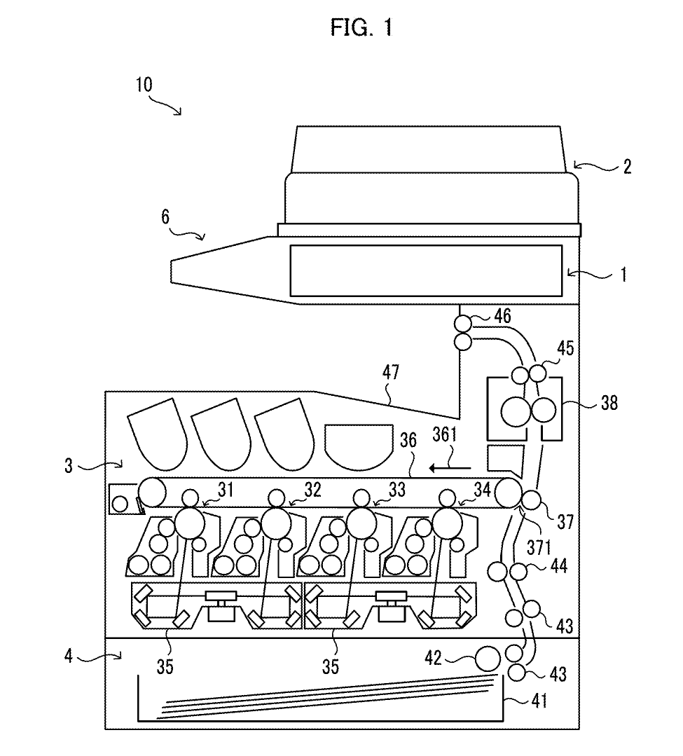

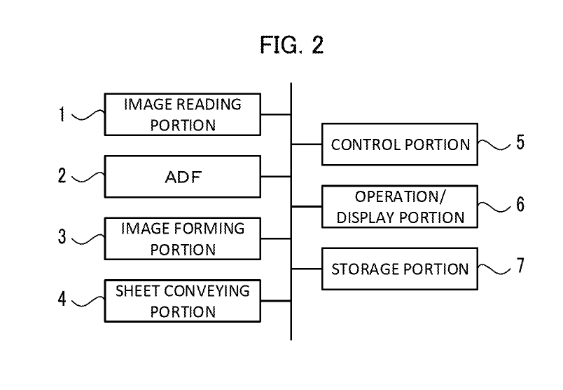

First, a description is given of an outline configuration of an image forming apparatus 10 according to an embodiment of the present disclosure, with reference to FIG. 1 and FIG. 2. As shown in FIG. 1 and FIG. 2, the image forming apparatus 10 includes an image reading portion 1, an ADF 2, an image forming portion 3, a sheet conveying portion 4, a control portion 5, an operation/display portion 6, and a storage portion 7. The image forming apparatus 10 is a multifunction peripheral having a plurality of functions such as a print function to form an image based on image data, a scan function, a facsimile function, and a copy function. It is noted that the present disclosure is not limited to a multifunction peripheral, but is applicable to an arbitrary image forming apparatus such as a printer apparatus, a facsimile apparatus, and a copier.

The image reading portion 1 includes a contact glass, a reading unit, a mirror, an optical lens, and a CCD (Charge Coupled Device). The image reading portion 1 is configured to read image data from a document sheet placed on the contact glass by being controlled by the control portion 5. The read image data is input to the control portion 5.

The ADF 2 is an automatic document feeding device including a document sheet setting portion, a plurality of conveyance rollers, a document sheet pressing, and a sheet discharge portion. The ADF 2 feeds a document sheet set on the document sheet setting portion so that the document sheet passes through a reading position on the contact glass, and conveys the document sheet to the sheet discharge portion. During this process, image data is read from the document sheet passing the reading position, by the image reading portion 1.

The image forming portion 3 is configured to form an image on a sheet by the electrophotography, based on image data read by the image reading portion 1, or based on image data input from an external information processing apparatus such as a personal computer. It is noted that the sheet is a sheet material such as a sheet of paper, a sheet of coated paper, a postcard, an envelope, or an OHP sheet.

Specifically, the image forming portion 3 includes a plurality of image forming units 31 to 34, laser scanning devices 35, an intermediate transfer belt 36, a secondary transfer roller 37, and a fixing device 38. It is noted that the printing operation of the image forming portion 3 is described below.

The image forming units 31 to 34 are arranged in order of an image forming unit 31, an image forming unit 32, an image forming unit 33, and an image forming unit 34 along a running direction 361 of the intermediate transfer belt 36 from an upstream side in the running direction 361. The image forming unit 31 is an electrophotographic image forming unit corresponding to a Y (yellow) color channel (color component). In addition, the image forming units 32, 33 and 34 are electrophotographic image forming units corresponding to C (cyan), M (magenta) and K (black) color channels, respectively. It is noted that in the following, the Y color channel is referred to as a Y channel, the C color channel is referred to as a C channel, the M color channel is referred to as an M channel, and the K color channel is referred to as a K channel. Each of the image forming units 31 to 34 includes a photoconductor drum, a charging device, a developing device, a primary transfer roller, and a cleaning device.

In the image forming unit 31, the charging device uniformly charges the photoconductor drum to a predetermined potential. Subsequently, the laser scanning device 35 irradiates a laser beam to the surface of the photoconductor drum based on the image data. This allows an electrostatic latent image corresponding to the image data to be formed on the surface of the photoconductor drum. The electrostatic latent image on the photoconductor drum is then developed (visualized) by the developing device as a yellow toner image. Specifically, toner is supplied from the developing device to the photoconductor drum. This allows the electrostatic latent image on the photoconductor drum to be developed as a toner image. The yellow toner image formed on the photoconductor drum is transferred to the intermediate transfer belt 36 by the primary transfer roller.

In the image forming units 32 to 34, too, toner images of respective colors are formed on the photoconductor drums of the image forming units 32 to 34, and the toner images of the respective colors are transferred to the intermediate transfer belt 36 in the same processing procedure as in the image forming unit 31.

It is noted that timings of the image forming units 31 to 34 at which the electrostatic latent image is written (namely, at which the laser scanning device 35 starts irradiating the laser beam to the surface of the photoconductor drum based on the image data) are shifted from each other. Specifically, writings of the electrostatic latent images to the photoconductor drums are started in sequence in order of the image forming unit 31, the image forming unit 32, the image forming unit 33, and the image forming unit 34. As a result, the toner images of respective colors are transferred to the intermediate transfer belt 36 in order of yellow, cyan, magenta, and black so that the toner images are overlaid on the intermediate transfer belt 36. The toner images transferred to the intermediate transfer belt 36 in this way are conveyed by the intermediate transfer belt 36 to a secondary transfer position 371 for a secondary transfer by the secondary transfer roller 37.

On the other hand, the sheet conveying portion 4 supplies a sheet to the secondary transfer position 371 to match a conveyance timing at which the intermediate transfer belt 36 conveys the toner image to the secondary transfer position 371. Specifically, a top sheet among the sheets stored in a sheet feed cassette 41 is fed to a conveyance path by a pick-up roller 42. The sheet fed to the conveyance path by the pick-up roller 42 is conveyed by a pair of first conveyance rollers 43 to a pair of registration rollers 44.

The pair of registration rollers 44 convey the sheet to the secondary transfer position 371 to match the conveyance timing. It is noted that the conveyance timing is determined by the control portion 5 as described below. The secondary transfer roller 37, at the secondary transfer position 371, transfers the toner image formed on the intermediate transfer belt 36 to the sheet conveyed by the pair of registration rollers 44. This allows an image to be formed on the sheet. It is noted that a registration sensor is provided at an upstream of the pair of registration rollers 44 in the sheet conveyance direction.

The toner image transferred to the sheet is heated by the fixing device 38 when the sheet passes through the fixing device 38. This allows the toner image to be fixed to the sheet. Thereafter, the sheet with the toner image fixed thereto is discharged to a sheet discharge portion 47 by a pair of second conveyance rollers 45 and a pair of discharge rollers 46.

It is noted that the image forming portion 3 includes a known contact/separation mechanism (not shown) that causes, among the plurality of photoconductor drums, photoconductor drums corresponding to color channels other than the K channel and transfer rollers to contact and separate from the intermediate transfer belt 36. The contact/separation mechanism is driven by a driving means such as a stepping motor, and the driving means is controlled by the control portion 5.

The control portion 5 includes control equipment such as a CPU, a ROM, and a RAM. The CPU is a processor that executes various calculation processes. The ROM is a nonvolatile storage portion in which various information such as control programs for causing the CPU to execute various processes are stored in advance. The RAM is a volatile or nonvolatile storage portion that is used as a temporary storage memory (working area) for the various processes executed by the CPU. The control portion 5 causes the CPU to execute various control programs stored in the ROM in advance. This allows the control portion 5 to control the image forming apparatus 10 comprehensively. It is noted that the control portion 5 may be composed of an electronic circuit such as an integrated circuit (ASIC), or may be a control portion provided independently of a main control portion that controls the image forming apparatus 10 comprehensively.

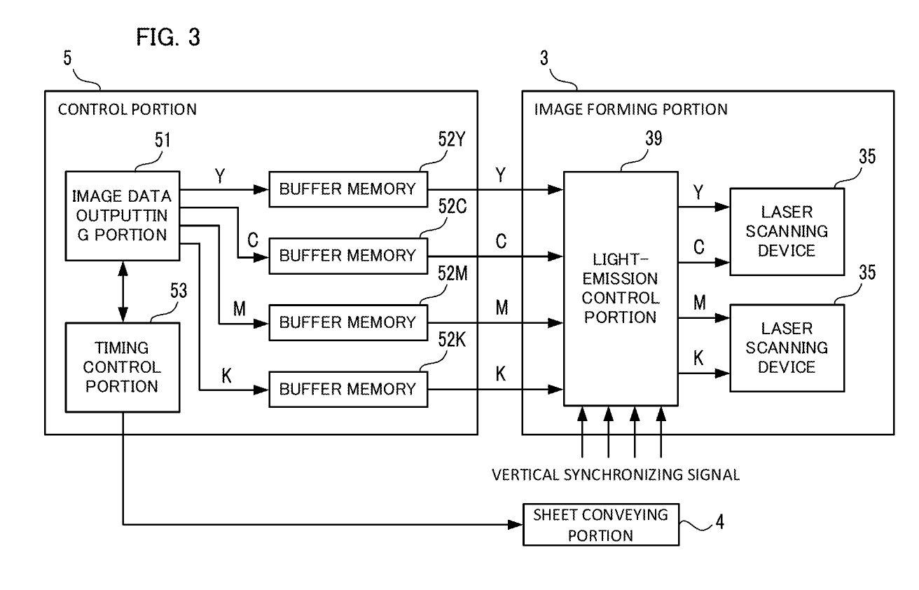

As shown in FIG. 3, the control portion 5 includes an image data outputting portion 51, buffer memories 52Y, 52C, 52M and 52K, and a timing control portion 53. It is noted that the image data outputting portion 51 and the timing control portion 53 may be integrated circuits such as the ASIC, or may be partial functions that are provided by processes of a calculation means such as the CPU.

The image data outputting portion 51 is configured to output image data of the Y, C, M and K color channels individually. The image mentioned here is image data that was read by the image reading portion 1 and has been subjected to various types of imaging processes.

The buffer memories 52Y, 52C, 52M and 52K are provided respectively in correspondence with the Y, C, M and K color channels, and temporarily store image data of the respective color channels output from the image data outputting portion 51. The buffer memories 52Y, 52C, 52M and 52K are provided in a volatile storage portion such as SDRAM (Synchronous Dynamic Random Access Memory), for example.

Each of the buffer memories 52Y, 52C, 52M and 52K is configured to store image data of the corresponding color channel with a predetermined data size (for example, 1 to 10 lines) that is determined in advance for each of the buffer memories 52Y, 52C, 52M and 52K.

The timing control portion 53 controls a sheet conveyance timing of the sheet conveying portion 4 so that the image is formed at a correct position on the sheet conveyed by the sheet conveying portion 4. Detailed operation of the timing control portion 53 is described below.

On the other hand, as shown in FIG. 3, the image forming portion 3 includes a light-emission control portion 39. The light-emission control portion 39 reads image data of the respective color channels from the buffer memories 52Y, 52C, 52M and 52K in synchronization with the sheet conveyance timing of the sheet conveying portion 4. Specifically, the light-emission control portion 39 reads image data of the respective color channels from the buffer memories 52Y, 52C, 52M and 52K in accordance with vertical synchronizing signals that are input respectively in correspondence with the Y, C, M and K color channels. Subsequently, the light-emission control portion 39 generates, in correspondence with the image data of the respective color channels read from the buffer memories 52Y, 52C, 52M and 52K, control signals for controlling the light emission of the light source of the laser scanning device 35, and supplies the control signals to the laser scanning device 35. Upon receiving the control signals, the laser scanning device 35 irradiates laser beams to the photoconductor drums of the image forming units 31 to 34 based on the control signals. This allows electrostatic latent images corresponding to image data of the respective color channels to be formed on the photoconductor drums. It is noted that the vertical synchronizing signals are supplied from the control portion 5 or the sheet conveying portion 4, for example.

The control portion 5 obtains document sheet information that indicates contents of image data of a document sheet that is a target of printing (hereinafter, the image data is referred to as “document sheet data”), and switches a print mode between a color print mode and a monochrome print mode based on the obtained document sheet information. The control portion 5 is an example of the print mode control portion of the present disclosure. For example, the document sheet data is image data read by the image reading portion 1, image data input from an external personal computer (information processing apparatus), or image data stored in advance in the storage portion 7 or the like. The document sheet information may include information that indicates the number of pages of monochrome image data and the number of pages of color image data that are contained in the document sheet data.

In a case where the document sheet data is color image data, the control portion 5 sets the print mode to the color print mode in which printing is executed by using the image forming units 31 to 34. In addition, in a case where the document sheet data is monochrome image data, the control portion 5 sets the print mode to the monochrome print mode in which printing is executed by using only the image forming unit 34.

Meanwhile, in the monochrome print mode, the image forming units 31 to 33 need not be operated. As a result, when the print mode is switched from the color print mode to the monochrome print mode, a mechanical switch process is performed in which the contact/separation mechanism is driven, for example. However, if the print mode is switched from the color print mode to the monochrome print mode during a continuous printing of a plurality of pages of images, the productivity may be reduced since the mechanical switch process takes a time. In view of this, to suppress such a reduction of the productivity, the control portion 5 does not switch the print mode during a continuous printing in the color print mode, unless a predetermined number of pages (for example, 18 pages) of monochrome images continue to be printed.

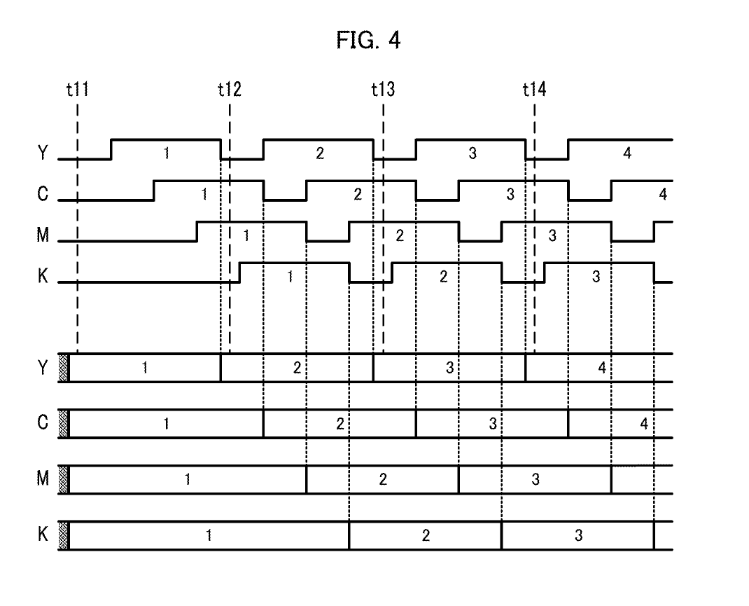

However, in a case where monochrome image pages are printed in the color print mode, the processing speed may become lower than a case where color image pages are printed. The reason for this is described in the following with reference to FIG. 4 to FIG. 6.

[Printing Operation in Continuous Printing of Color Image Data in Color Print Mode]

First, a printing operation in a continuous printing of color image data in the color print mode is described with reference to FIG. 4.

As shown in the upper part of FIG. 4, in the color print mode, the vertical synchronizing signals corresponding to the respective color channels are input to the light-emission control portion 39 at intervals of time that correspond to intervals at which the photoconductor drums of the image forming units 31 to 34 are arranged. The light-emission control portion 39 then reads the image data of the respective color channels from the buffer memories 52Y, 52C, 52M and 52K at intervals of time in accordance with the vertical synchronizing signals corresponding to the image data of the respective color channels contained in the document sheet data.

The lower part of FIG. 4 shows page numbers of the image data stored in the buffer memories 52Y, 52C, 52M and 52K. When a print request is accepted, first, image data of the respective color channels of the first page is output from the image data outputting portion 51 to the buffer memories 52Y, 52C, 52M and 52K. Upon confirming that image data of a head channel (in this example, the Y channel) of the first page is stored in the buffer memory 52Y, the timing control portion 53, at time t11, outputs a sheet feed request requesting conveyance of a sheet for the first page, to the sheet conveying portion 4. In response to the sheet feed request, the sheet conveying portion 4 conveys the sheet for the first page at a predetermined timing from the pair of registration rollers 44 toward the secondary transfer position 371. It is noted that the head channel refers to a color channel for which the vertical synchronizing signal rises first in the color print mode, and in the present embodiment, the Y channel is the head channel. When the image data of the head channel is stored in the buffer memory 52Y, it means that the image data of the other color channels is also stored in the buffer memories 52C, 52M and 52K (or, the image data outputting portion 51 is ready to output the image data of the other color channels).

The vertical synchronizing signals of the color channels rise in synchronization with the sheet conveyance timing of the sheet conveying portion 4. That is, the vertical synchronizing signals of the respective color channels rise in sequence at predetermined time intervals determined in advance for the respective color channels, after the sheet feed request is output from the timing control portion 53. The image data stored in the buffer memories 52Y, 52C, 52M and 52K starts to be read by the light-emission control portion 39 at timings at which the corresponding vertical synchronizing signals rise. It is noted that the capacity of each of the buffer memories 52Y, 52C, 52M and 52K is a data size of approximately 1 to 10 lines of image data. As a result, outputing image data to the buffer memories 52Y, 52C, 52M and 52K by the image data outputting portion 51 is performed in parallel to reading image data from the buffer memories 52Y, 52C, 52M and 52K by the light-emission control portion 39.

Upon completion of reading image data of the head channel (Y channel) of the first page from the buffer memory 52Y, the image data outputting portion 51 outputs image data of the head channel of the second page to the buffer memory 52Y. Upon confirming that the image data of the head channel (Y channel) of the first page has been read from the buffer memory 52Y, and that a part of the image data of the second page (in this example, the image data of the Y channel of the second page) is stored in the buffer memory 52Y, the timing control portion 53, at time t12, outputs a sheet feed request requesting conveyance of a sheet for the second page, to the sheet conveying portion 4. In response to the sheet feed request, the sheet conveying portion 4 conveys the sheet for the second page, at a predetermined timing, from the pair of registration rollers 44 toward the secondary transfer position 371. A similar process is repeated with respect to the third page and onward.

As described above, in the color print mode, the timing control portion 53 requests the sheet conveying portion 4 to convey a sheet for the next page in a case where: a reading completion timing at which reading image data of the head channel (Y channel) of an arbitrary page from the buffer memory 52Y is to be completed (for example, a timing at which the vertical synchronizing signal corresponding to the head channel falls, or a timing which is earlier than the vertical synchronizing signal falling timing by a predetermined time period), has passed; and a part of image data of the next page (in this example, image data of the Y channel of the second page) is stored in a corresponding buffer memory (in this example, the buffer memory 52Y).

[Printing Operation in Continuous Printing of Monochrome Image Data in Monochrome Print Mode]

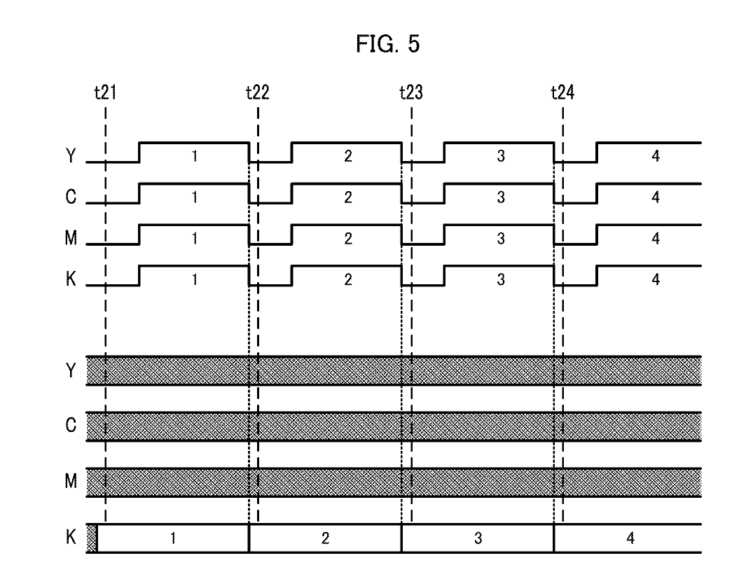

Next, a printing operation in a continuous printing of monochrome image data (for example, image data including only the K channel) in the monochrome print mode is described with reference to FIG. 5. It is noted that in the monochrome print mode, the control portion 5 separates the photoconductor drums and the primary transfer rollers of the image forming units 31 to 33 corresponding to Y, C and M, from the intermediate transfer belt 36 by driving the contact/separation mechanism of the image forming portion 3.

As shown in the upper part of FIG. 5, in the monochrome print mode, the vertical synchronizing signals corresponding to the respective color channels rise at the same timing. The lower part of FIG. 5 shows the page numbers of image data stored in the buffer memory 52K. It is noted that since the monochrome image data does not include image data of color channels other than the K channel, the buffer memories 52Y, 52C and 52M are empty. When a print request is accepted, first, image data of the K channel of the first page is output from the image data outputting portion 51 to the buffer memory 52K. Upon confirming that the image data of the K channel of the first page is stored in the buffer memory 52K, the timing control portion 53, at time t21, outputs a sheet feed request requesting conveyance of a sheet for the first page, to the sheet conveying portion 4. In response to the sheet feed request, the sheet conveying portion 4 conveys the sheet for the first page at a predetermined timing from the pair of registration rollers 44 toward the secondary transfer position 371.

The vertical synchronizing signal of the K channel rises after a predetermined time period passes since an output of the sheet feed request from the timing control portion 53. The image data stored in the buffer memory 52K starts to be read by the light-emission control portion 39 at a timing when the vertical synchronizing signal rises. In parallel to reading the image data from the buffer memory 52K by the light-emission control portion 39, outputting image data to the buffer memory 52K by the image data outputting portion 51 is performed.

Upon completion of reading the image data of the K channel of the first page from the buffer memory 52K, the image data outputting portion 51 outputs image data of the K channel of the second page to the buffer memory 52K. Upon confirming that the image data of the K channel of the first page has been read from the buffer memory 52K, and that image data of the K channel of the second page is stored in the buffer memory 52K, the timing control portion 53, at time t22, outputs a sheet feed request requesting conveyance of a sheet for the second page, to the sheet conveying portion 4. In response to the sheet feed request, the sheet conveying portion 4 conveys the sheet for the second page at a predetermined timing from the pair of registration rollers 44 toward the secondary transfer position 371. A similar process is repeated with respect to the third page and onward.

[Printing Operation in Continuous Printing of Monochrome Image Data in Color Print Mode]

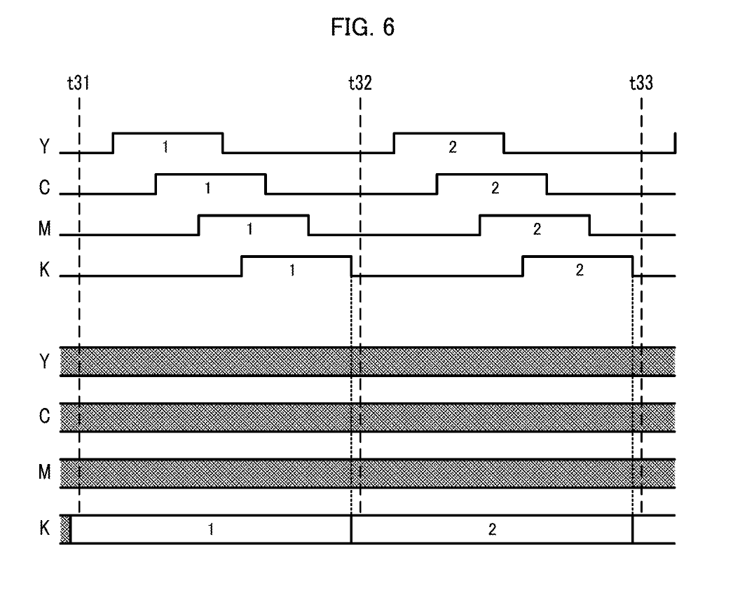

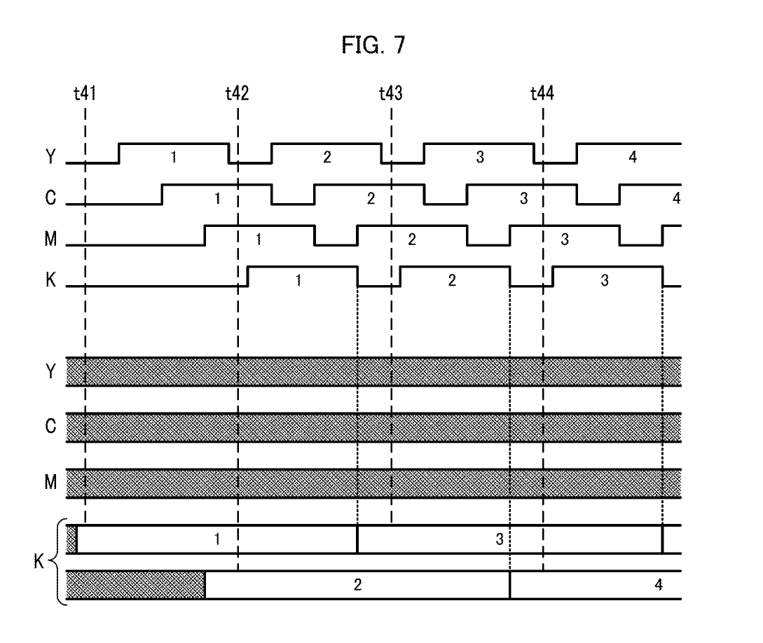

Next, a printing operation in a continuous printing of monochrome image data in the color print mode is described with reference to FIG. 6 and FIG. 7. It is noted that FIG. 6 shows a printing operation in an image forming apparatus of a comparative example to help understand the present disclosure, and FIG. 7 shows a printing operation in the image forming apparatus 10 according to the present embodiment.

First, a printing operation in the image forming apparatus of the comparative example is described with reference to FIG. 6. It is noted that for convenience's sake, the reference signs assigned to the image forming apparatus 10 of the present embodiment are also used to indicate the corresponding components of the image forming apparatus of the comparative example.

As shown in the upper part of FIG. 6, in the color print mode, the vertical synchronizing signals corresponding to the respective color channels are input to the light-emission control portion 39 at intervals of time corresponding to the intervals at which the photoconductor drums of the image forming units 31 to 34 are arranged. The light-emission control portion 39 then reads the image data of the K channel from the buffer memory 52K in accordance with the vertical synchronizing signal corresponding to the image data of the K channel. That is, in the color print mode, even when the document sheet data includes only a part (for example, the K channel) of the Y, C, M and K color channels, the image forming portion 3 forms an image on the sheet by reading image data of the part of the color channels at the same timing as in the case where the document sheet data includes all of the Y, C, M and K color channels.

The lower part of FIG. 6 shows page numbers of the image data stored in the buffer memory 52K. It is noted that since the monochrome image data does not include image data of color channels other than the K channel, the buffer memories 52Y, 52C and 52M are empty. When a print request is accepted, first, image data of the K channel of the first page is output from the image data outputting portion 51 to the buffer memory 52K. Upon confirming that the image data of the K channel of the first page is stored in the buffer memory 52K, the timing control portion 53, at time t31, outputs a sheet feed request requesting conveyance of a sheet for the first page, to the sheet conveying portion 4. In response to the sheet feed request, the sheet conveying portion 4 conveys the sheet for the first page at a predetermined timing from the pair of registration rollers 44 toward the secondary transfer position 371.

The vertical synchronizing signals of the respective color channels rise in synchronization with the sheet conveyance timing of the sheet conveying portion 4. That is, the vertical synchronizing signals of the respective color channels rise in sequence at predetermined time intervals determined in advance for the respective color channels, after the sheet feed request is output from the timing control portion 53. The image data stored in the buffer memory 52K starts to be read by the light-emission control portion 39 at the timing at which the vertical synchronizing signal corresponding to the K channel rises. Outputting image data to the buffer memory 52K by the image data outputting portion 51 is performed in parallel to reading image data from the buffer memory 52K by the light-emission control portion 39.

Upon completion of reading the image data of the K channel of the first page from the buffer memory 52K, the image data outputting portion 51 outputs image data of the K channel of the second page to the buffer memory 52K.

As described above, in the color print mode, the timing control portion 53 requests the sheet conveying portion 4 to convey a sheet for the next page in a case where: a reading completion timing at which reading image data of the head channel (Y channel) of an arbitrary page from the buffer memory 52Y is to be completed (for example, a timing at which the vertical synchronizing signal corresponding to the head channel falls, or a timing which is earlier than the vertical synchronizing signal falling timing by a predetermined time period), has passed; and a part of image data of the next page (in this example, image data of the Y channel of the second page) is stored in a corresponding buffer memory (in this example, the buffer memory 52Y). As a result, in this comparative example, upon confirming that a part of the image data of the second page (in this example, the image data of the K channel of the second page) is stored in the buffer memory 52K, the timing control portion 53, at time t32, outputs a sheet feed request requesting conveyance of a sheet for the second page, to the sheet conveying portion 4. A similar process is repeated with respect to the third page and onward.

Here, the timing at which the sheet feed request for the second page is output by the timing control portion 53 in FIG. 6 (namely, time t32) is later than the timing at which the sheet feed request for the second page is output by the timing control portion 53 in FIG. 4 (namely, time t12). The same applies to the third page and onward. In this way, the processing speed in a case where monochrome image pages are printed in the color print mode may be reduced compared to a case where color image pages are printed in the color print mode.

It is noted that in order to prevent such reduction of the processing speed in a case where monochrome image pages are printed in the color print mode, the timing control portion 53 may output the sheet feed request at the same timing as that shown in FIG. 4. However, in this case, the sheet for the next page is conveyed in a state where it is not known whether or not the image data outputting portion 51 is ready to output image data of the next page to the buffer memory 52K. As a result, if the image data outputting portion 51 cannot output the image data of the next page before a rise of the vertical synchronizing signal of the K channel, a malfunction such as discharging a blank sheet without image may occur.

On the other hand, according to the image forming apparatus 10 of the present embodiment, with a configuration and operation described in the following, it is possible to suppress reduction of the processing speed when monochrome image data is printed in the color print mode. The following describes, with reference to FIG. 7, the print operation in the image forming apparatus 10 according to the present embodiment.

In the present embodiment, in the color print mode, even in a case where the document sheet data includes only a part (for example, the K channel) of the Y, C, M and K color channels, the image forming portion 3 reads image data of the part of the color channels from the corresponding buffer memory at the same timing as in a case where the document sheet data includes all of the Y, C, M and K color channels, and forms an image on a sheet.

In addition, according to the present embodiment, in a case where the document sheet data includes only a part (for example, the K channel) of the Y, C, M and K color channels, the image data outputting portion 51 outputs image data only to the buffer memory (for example, the buffer memory 52K) of the part of the color channels.

In the image forming apparatus 10 according to the present embodiment, the buffer memory 52K of the K channel (an example of the predetermined channel of the present disclosure) is configured to store image data of two different pages individually. The image data outputting portion 51, after it starts outputting image data of the K channel of the first page to the buffer memory 52K, starts outputting image data of the K channel of the second page to the buffer memory 52K regardless of whether or not the image data of the K channel of the first page has been read from the buffer memory 52K.

The lower part of FIG. 7 shows page numbers of image data stored in the buffer memory 52K. When a print request is accepted, first, image data of the K channel of the first page is output from the image data outputting portion 51 to the buffer memory 52K. Upon confirming that the image data of the K channel of the first page is stored in the buffer memory 52K, the timing control portion 53, at time t41, outputs a sheet feed request requesting conveyance of a sheet for the first page, to the sheet conveying portion 4. In response to the sheet feed request, the sheet conveying portion 4 conveys the sheet for the first page at a predetermined timing from the pair of registration rollers 44 toward the secondary transfer position 371.

The vertical synchronizing signals of the respective color channels rise in synchronization with the sheet conveyance timing of the sheet conveying portion 4. That is, the vertical synchronizing signals of the respective color channels rise in sequence at predetermined time intervals determined in advance for the respective color channels, after the sheet feed request is output from the timing control portion 53. The image data stored in the buffer memory 52K starts to be read by the light-emission control portion 39 at a timing at which a vertical synchronizing signal corresponding to the K channel rises. In parallel to reading the image data from the buffer memory 52K by the light-emission control portion 39, outputting image data to the buffer memory 52K by the image data outputting portion 51 is performed. In addition, the image data outputting portion 51 outputs image data of the K channel of the second page to the buffer memory 52K regardless of whether or not the image data of the K channel of the first page has been read from the buffer memory 52K. That is, the image data outputting portion 51 outputs the image data of the K channel of the second page to the buffer memory 52K when it becomes possible to output the image data of the K channel of the second page.

As described above, in the color print mode, the timing control portion 53 requests the sheet conveying portion 4 to convey a sheet for the next page in a case where: a reading completion timing at which reading image data of the head channel (Y channel) of an arbitrary page from the buffer memory 52Y is to be completed, has passed; and a part of image data of the next page is stored in the corresponding buffer memory. Accordingly, in this comparative example, upon confirming that a reading completion timing at which reading image data of the head channel (Y channel) of the first page from the buffer memory 52Y is to be completed (for example, a timing at which the vertical synchronizing signal corresponding to the head channel falls, or a timing which is earlier than the vertical synchronizing signal falling timing by a predetermined time period), has passed, and that image data of the K channel of the second page is stored in the buffer memory 52K, the timing control portion 53, at time t42, outputs a sheet feed request requesting conveyance of a sheet for the second page, to the sheet conveying portion 4. A similar process is repeated with respect to the third page and onward.

As described above, according to the present embodiment, even in a state where image data of an arbitrary page is stored in the buffer memory 52K, storing image data of the next page in the buffer memory 52K is performed when it becomes possibe for the image data outputting portion 51 to output the image data of the next page. As a result, a timing at which the sheet conveying portion 4 outputs a sheet feed request is not delayed as in the comparative example shown in FIG. 6, and in the color print mode, it is possible to suppress reduction of the processing speed in a case where monochrome image data is printed in the color print mode. Furthermore, a sheet for the next page is conveyed after it is confirmed that image data of the next page is stored in the buffer memory 52K. This makes it possible to suppress occurrence of a malfunction where, for example, a blank sheet without image is discharged.

[Timing Control Process]

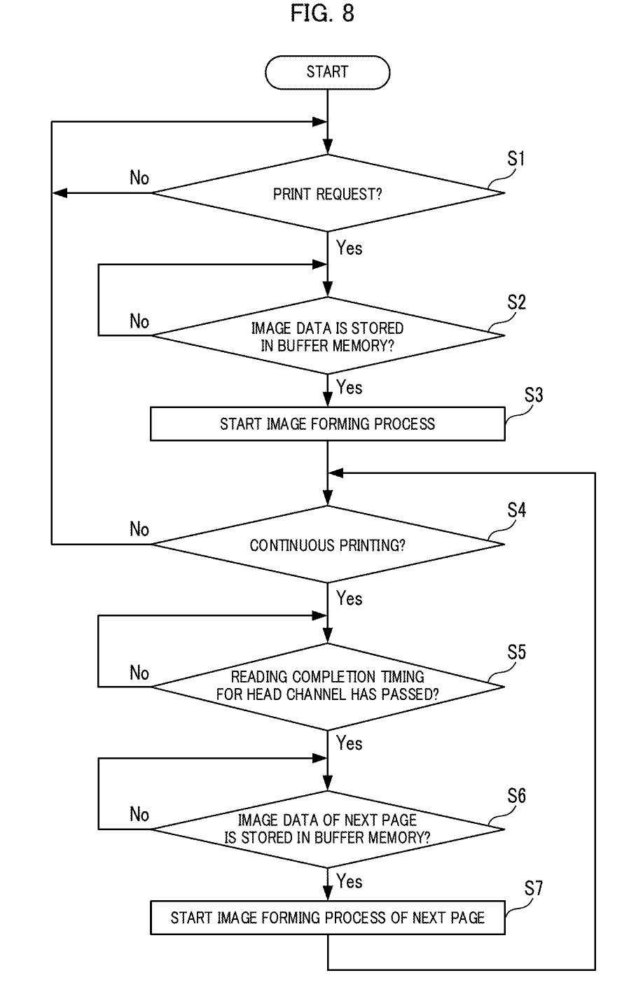

In the following, a timing control process executed by the control portion 5 (specifically, the timing control portion 53) in the image forming apparatus 10 is described with reference to FIG. 8. Here, steps S1, S2, . . . represent numbers assigned to the processing procedures (steps) executed by the control portion 5. It is noted that, for example, the timing control process is started in response to a power-on of the image forming apparatus 10, and ended in response to a power-off of the image forming apparatus 10.

<Step S1>

First, in step S1, the control portion 5 determines via the operation/display portion 6 or the like whether or not a print request has been input. Upon determining that a print request has been input (S1: Yes), the process moves to step S2. On the other hand, upon determining that a print request has not been input (S1: No), the process of step S1 is repeated until it is determined that a print request has been input.

<Step S2>

In step S2, the control portion 5 determines whether or not image data of the first page is stored in any of the buffer memories 52Y, 52C, 52M and 52K. Upon determining that image data of the first page is stored (S2: Yes), the process moves to step S3. On the other hand, upon determining that image data of the first page is not stored (S2: No), the process of step S2 is repeated until it is determined that image data of the first page is stored.

<Step S3>

In step S3, the control portion 5 starts an image forming process of the first page based on image data of the first page. Specifically, the control portion 5 outputs a sheet feed request requesting conveyance of a sheet for the first page, to the sheet conveying portion 4. Thereafter, the sheet for the first page is conveyed at a predetermined timing from the pair of registration rollers 44 toward the secondary transfer position 371, and the image data of the first page is printed on the sheet.

<Step S4>

In step S4, the control portion 5 determines whether or not to perform a continuous printing. Specifically, the control portion 5 determines to perform a continuous printing when another page is to be printed following the currently printed page (hereinafter referred to as a “current page”). When the control portion 5 determines to perform a continuous printing (S4: Yes), the process moves to step S5. On the other hand, when the control portion 5 determines not to perform a continuous printing (S4: No), the process returns to the step S1.

<Step S5>

In step S5, the control portion 5 determines whether or not a reading completion timing at which reading image data of the head channel (Y channel) of the current page from the buffer memory 52Y is to be completed, has passed. When it is determined that the reading completion timing has passed (S5: Yes), the process moves to step S6. On the other hand, when it is determined that the reading completion timing has not passed (S5: No), the process of step S5 is repeated until it is determined that the reading completion timing has passed.

<Step S6>

In step S6, the control portion 5 determines whether or not image data of the next page is stored in any of the buffer memories 52Y, 52C, 52M and 52K. When it is determined that image data of the next page is stored (S6: Yes), the process moves to step S7. On the other hand, when it is determined that image data of the next page is not stored (S6: No), the process of step S6 is repeated until it is determined that image data of the next page is stored.

<Step S7>

In step S7, the control portion 5 starts an image forming process of the next page based on the image data of the next page. Specifically, the control portion 5 outputs a sheet feed request requesting conveyance of a sheet for the next page, to the sheet conveying portion 4. Thereafter, the sheet for the next page is conveyed at a predetermined timing from the pair of registration rollers 44 toward the secondary transfer position 371, and the image data of the next page is printed on the sheet. Subsequently, the process of the steps S4 to S7 is repeated until the control portion 5 determines in the step S4, not to perform the continuous printing.

As described above, according to the image forming apparatus 10 of the present embodiment, even in a state where image data of an arbitrary page is stored in the buffer memory 52K, storing image data of the next page in the buffer memory 52K is performed when it becomes possible for the image data outputting portion 51 to output the image data of the next page. As a result, even in a case where monochrome image data is printed in the color print mode, a timing at which the sheet conveying portion 4 outputs a sheet feed request is not delayed, and it is possible to suppress reduction of the processing speed. Furthermore, a sheet for the next page is conveyed after it is confirmed that image data of the next page is stored in the buffer memory 52K. This makes it possible to suppress, for example, occurrence of a malfunction where a blank sheet without image is discharged.

It is noted that in the present embodiment, among the image forming units 31 to 34, the image forming unit 34 corresponding to the K channel is located on the most downstream side in the running direction 361 of the intermediate transfer belt 36. However, the present disclosure is not limited to this configuration. The present disclosure is applicable to a case where the image forming unit 34 corresponding to the K channel is the second or third one from the upstream side in the running direction 361 of the intermediate transfer belt 36. In any case. the buffer memory 52K corresponding to the K channel needs to be configured to store image data of two different pages individually. It is noted that the delay of the processing speed that is described above with reference to FIG. 6, becomes maximum in a case where the image forming unit 34 corresponding to the K channel is located on the most downstream side (namely, a case where image data of the K channel, among the Y, C, M and K color channels, is read last from a buffer memory). Accordingly, the present disclosure is particularly effective in a case where image data of the K channel, among the Y, C, M and K color channels, is read last from a buffer memory.

In addition, the present embodiment describes a case where monochrome image data is continuously printed in the color print mode. However, the present disclosure is not limited to the case. The present disclosure is also effective in a case where, in the color print mode, image data which is composed of one or more color channels other than the head channel (in this example, the Y channel) is printed. For example, the present disclosure is effective in a case where document sheet data that includes image data of only two color channels, for example, the C channel and the M channel, is printed. However, in this case, the buffer memory 52C corresponding to the C channel needs to be configured to store image data of two different pages individually. In addition, the present disclosure is effective in a case where, for example, document sheet data that includes image data of only the M channel is printed. However, in this case, the buffer memory 52M corresponding to the M channel needs to be configured to store image data of two different pages individually.

In addition, the present embodiment describes a case where the head channel in the color print mode is the Y channel. However, the present disclosure is not limited to the case. The present disclosure is also effective in a case where the head channel is other than the Y channel (for example, a case where the head channel is the C channel or the M channel).

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
a sheet conveying portion configured to convey a sheet;
an image data outputting portion configured to output image data of a plurality of color channels individually;
a plurality of buffer memories provided respectively in correspondence with the plurality of color channels, and configured to temporarily store the image data of the plurality of color channels output from the image data outputting portion;
an image forming portion configured to read the image data of the plurality of color channels in sequence in an order from a head color channel from the plurality of buffer memories at timings different for each of the plurality of color channels in synchronization with a sheet conveyance timing at which the sheet conveying portion conveys the sheet; and
a timing control portion configured to request the sheet conveying portion to convey a sheet for a second page that is next to a first page, which is an arbitrary page, in a case where: a reading completion timing at which reading image data of the head color channel of the first page from a corresponding buffer memory is to be completed, has passed; and a part of image data of the second page is stored in the corresponding buffer memory, wherein
at least one of the plurality of buffer memories corresponding to at least one predetermined channel among the plurality of color channels other than the head color channel is configured to store image data of two different pages individually, and
after the image data outputting portion starts outputting image data of the first page to the buffer memory corresponding to the predetermined channel, the image data outputting portion starts outputting image data of the second page to the buffer memory regardless of whether or not the image data of the first page has been read from the buffer memory.

2. The image forming apparatus according to claim 1, further comprising:
a print mode control portion configured to switch a print mode between a color print mode and a monochrome print mode, wherein
in the color print mode, even when the image data includes only a part of the plurality of color channels, the image forming portion forms an image on the sheet by reading image data of the part of the plurality of color channels at the same timing as in a case where the image data includes all of the plurality of color channels.

3. The image forming apparatus according to claim 1, wherein
in a case where the image data includes only a part of the plurality of color channels, the image data outputting portion outputs the image data only to a buffer memory corresponding to the part of the plurality of color channels.

4. The image forming apparatus according to claim 1, wherein
the plurality of color channels respectively correspond to yellow, cyan, magenta, and black, and
image data of a color channel corresponding to black, among the plurality of color channels, is read last from a corresponding buffer memory by the image forming portion.

5. The image forming apparatus according to claim 1, wherein
the image forming portion includes a photoconductor and a developing portion for each of the plurality of color channels, and generates toner images respectively of the plurality of color channels, based on the image data of the plurality of color channels read from the plurality of buffer memories, wherein the toner images are to be transferred to the sheet.
